(19) United States
(12) Patent Application Publication
(10) Pub. No.: US 2019/0187539 A1
(43) Pub. Date: Jun. 20, 2019

(54) Method and Apparatus for Photographic Image Capture Illumination

(71) Applicant: Nokia Technologies Oy, Espoo (FI)

(72) Inventors: Marja SALMIMAA, Tampere (FI); Toni JARVENPAA, Akaa (FI); Petri PIIPPO, Lempaala (FI); Tero JOKELA, Tampere (FI)

(21) Appl. No.: 16/310,071

(22) PCT Filed: Jun. 30, 2016
(86) PCT No.: PCT/FI2016/050485

§ 371 Date: Dec. 14, 2018

(51) Int. Cl. G03B 15/03; G03B 37/04; H04N 13/243; H04N 5/225; H04N 5/232; H04N 5/235

(52) U.S. Cl. CPC G03B 15/03; G03B 37/04; H04N 13/243; H04N 5/2354; H04N 5/2258; H04N 5/23238; H04N 5/2256

(57) ABSTRACT

A method and apparatus are disclosed for photographic image capture illuminating of a range surrounding a panorama camera that has plural objectives. The illumination is performed from plural positions of the panorama camera from between views of the plural objectives. The illumination is directionally adapted for intensity and/or spectrum for even illumination of entire panorama imaging area.

### TECHNICAL FIELD

The present document generally relates to photographic image capture illumination.

### BACKGROUND

This section illustrates useful background information without admission of any technique described herein representative of the state of the art.

Photographic image capture produces images, whether still or video frames, by recording or capturing photographic images, typically as obtained by optics such as an objective. The first devices were analog cameras that photo-chemically capturing the images on film. Digital cameras use image sensors that comprise numerous pixel detectors that detect the intensity of light of a given frequency band at a given part of an image being captured. 3D cameras capture two images with suitable offset to simulate the way in which human eyes operate, for presentation with 3D display devices. Yet further improvement in the field of photography is a virtual reality camera that captures spherical and stereoscopic video with an array of eight video sensors each equipped with 2K×2K pixel detectors. That camera covers a full-spherical range of 360×180 degrees, each lens covering 195 degrees.

Photography by definition requires light. Incoming photons are needed to capture optical images of a view seen by a camera. Flash lights and photography lamps have been designed to produce temporary or continuous illumination of the objects. The continuous illumination is particularly used in studios and generally stationary set-up where appropriate to pre-stage the illumination. In most ad-hoc photography situations, time does not permit using anything but ambient light and possibly attached flash gun or built-in flash of the camera. Such flash lights attached to the camera are convenient for use with hand-held cameras such as SLR cameras and camera phones, but their use is limited generally towards the direction of the camera's optical axis. They would not be suited for use with a full-spherical camera, for example, because of the limited range and because they would block some of the view of the image sensors.

### SUMMARY

Various aspects of examples of the invention are set out in the claims.

According to a first example aspect of the present invention, there is provided a method comprising:
illuminating for photographic image capture a range surrounding a panorama camera that comprises plural objectives;
performing the illumination from plural positions of the panorama camera from between views of the plural objectives; and
directionally adapting the illumination.

The method may further comprising measuring illumination need as a function of direction and accordingly performing the directional adapting of the illumination.

The illumination may be performed in two, three or more sectors collectively covering the entire field of view of the panorama cover.

The field of view of an objective may refer to a view that is being contained in the photographic image capture. The view may be a view seen by an image sensor of the panorama camera through the objective.

The method may comprise stitching a panorama image using the image information.

The panorama camera may be capable of capturing an image covering at least 270 degrees. Alternatively, the panorama camera may be capable of capturing an image covering at least 360 degrees.

The panorama camera may be capable of producing an image covering at least 270 degrees up to at least one pole. The coverage of the panorama camera may be at least 270 degrees by at least 100 degrees.

The panorama camera may be a 2D camera. Alternatively, the panorama camera may be a 3D camera.

The illuminating may be flash light illuminating. Alternatively, the illuminating may be continuous illuminating. Further alternatively, the illuminating may be continuous illuminating during one period of time and a flash light illumination during another period of time.

The directional adapting of the illumination may directionally vary intensity of the illumination. The directional adapting of the illumination may vary mutual intensities of plural illumination light sources. Some of the plural illumination light sources may be dimmed and/or some of the plural illumination light sources may be switched off. The plural illumination light sources may be grouped in plural groups. The varying of the mutual intensities may comprise varying mutual intensities of different illumination light sources within different groups so that each of the groups of light sources illuminates with desired collective power and spectral power distribution.

The directional adapting of the illumination may comprise adjusting optical path of an illumination light source. The adjusting of the optical path may comprise reconfiguring blockage for the illumination light source. The reconfiguring of the blockage may comprise any one or more of: moving a blocking object; moving the illumination light source with respect to the blocking object; and adapting mutual intensities of one or more of plural light source that are partly blocked by the blocking object. The plural light sources that are partly blocked by the blocking object may reside in a non-planar constellation.

The adjusting of the optical path of the illumination light source may comprise adapting refraction of at least one co-operating refractor. The refractor may comprise any one or more of: a lenslet; liquid crystal polarization rotator; and an actuated refractor. The refractor may comprise a lens or a prism.

The adjusting of the optical path of the at least one illumination light source may comprise adapting reflection of least one co-operating reflector. The reflector may comprise a mirror or a plural micro-mirrors configured to reflect the illumination to desired direction. The mirror or micro-mirrors may reside underneath the illumination light source. Underneath may refer to position as if the illumination light source were seen downwards from a frontal sector of the illumination light source. The adjusting of the optical path of the at least one illumination light source may comprise moving an optical path directing element by an actuator. The optical path directing element may comprise at least one reflector and/or refractor. The actuator may comprise one or more micro-actuators. The micro-actuators may comprise a microelectromechanical actuator. The adapting of the reflection may comprise selective blocking or absorption of illumination with a liquid crystal display screen.

The directional adapting of the illumination may directionally vary the spectrum of the illumination. The spectrum of the illumination may be controlled by adapting the spectrum of one illumination light source and/or a collective spectrum of plural illumination light sources. The spectrum of one illumination light source may be controlled by adapting the driving or pulse period of the illumination light source in case that the spectral response of the illumination light source is variable as a function of time. The spectrum of the illumination may be controlled by adapting mutual intensities of different sub-band illuminators that are configured to produce different sub-bands of desired spectrum of the illumination. The spectrum of the illumination may be controlled by adapting absorption spectrum of one or more illumination light sources. The adapting of the absorption spectrum may be performed with a controllably coloring absorption element such as a colored liquid crystal display element. The adapting of the absorption spectrum may be performed with dedicated controllable absorbers assigned for different sub-band illuminators.

The method may comprise determining desired spectrum of the illumination based on output of the panorama camera. The desired spectrum may be defined based on a choice of most likely successful image out of a plural images captured with the plural objectives. The desired spectrum may be defined based on measurement of spectral power distribution of ambient light. The spectral power distribution of ambient light may be measured with an ambient light sensor.

The illuminating for photographic image capture may comprise illuminating with two or more illumination light sources on different sides of one of the plural objectives to illuminate the field of view of the objective in question. The two or more illumination light sources may be configured to collectively produce a desired spectral power distribution. The desired spectral power distribution may be directionally variable within the field of view of the objective in question.

The illuminating may be performed using multi-frame flash in which plural flash pulses are issued in respective different periods during exposure of one image by the panorama camera. The plural flash pulses may differ by at least one of their directional power distribution; spectral power distribution variance as a function of direction; global power; and global spectral power spectrum. The directional power distribution may be varied by forming a desired illumination pattern. The illumination pattern may be symmetrical or asymmetrical. The global power or spectral power distribution may refer to the power or spectral power distribution by all of the used illumination light sources.

The method may comprise using one or more of the illumination light sources as photographing light to assist exposing images by the panorama camera and additionally as an infrared light illumination. The infrared light illumination may be used to obtain a depth map of proximate objects. The depth map may be used to control the directional adapting of the illumination.

The method may comprise automatically verifying disparity of a pair of images when the panorama camera is used for 3D imaging. If disparity exceeding a given threshold is identified, the illumination may be directionally adapted with such directional adaptation that the disparity is decreased to facilitate 3D imaging. The appearance of the Sun in the disparity verification may be detected in the image pair from a combination of brightness higher and disparity lower than usual with proximate objects.

The method may further comprise presenting an indication with the illumination light sources. The indication may comprise any of: a graphical symbol; digit; and letter. The indication may be used to indicate a countdown timer. The indication may be used to identify on proximate surfaces where seam regions will reside in subsequent stitching of panorama images given the position and orientation of the panorama camera.

According to a second example aspect of the present invention, there is provided an apparatus comprising:

a plurality of objectives configured to produce frames for a panorama image;

an image capture circuitry configured to obtain digital images corresponding to the views of the plural objectives;

a plurality of illumination light sources configured to produce illumination from plural positions of the panorama camera from between views of the plural objectives; and

a controller configured to directionally adapt the illumination.

The controller may comprise at least one processor configured to receive image information from the image capture circuitry and to process the image information.

The controller may be configured to stitch a panorama image using the image information.

The image capture circuitry may comprise a plurality of image sensors. The image capture circuitry may comprise one or more image sensors for one objective. The image capture circuitry may comprise an optically multiplexed image sensor configured to obtain image information from two or more objectives.

According to a third example aspect of the present invention, there is provided an apparatus comprising:

a communication circuitry configured to receive image information from a panorama camera comprising plural objectives, the image information corresponding to views of the plural objectives;

a controller configured to control illuminating for photographic image capture a range surrounding the panorama camera from plural positions of the panorama camera from between views of the plural objectives and to cause directionally adapting the illumination.

The controller may be further configured to cause performing any of the method steps defined in connection with the first example aspect.

The controller may comprise:

a memory;

a processor; and

computer executable program code configured to make the controller to perform its controlling when running the program code in the memory.

According to a fourth example aspect of the present invention, there is provided a computer program comprising computer executable program code configured to execute the method of the first or any embodiment thereof.

The computer program may be stored in a computer readable memory medium.

Any foregoing memory medium may comprise a digital data storage such as a data disc or diskette, optical storage, magnetic storage, holographic storage, opto-magnetic storage, phase-change memory, resistive random access memory, magnetic random access memory, solid-electrolyte memory, ferroelectric random access memory, organic memory or polymer memory. The memory medium may be formed into a device without other substantial functions than storing memory or it may be formed as part of a device with other functions, including but not limited to a memory of a computer, a chip set, and a sub assembly of an electronic device.

Different non-binding example aspects and embodiments of the present invention have been illustrated in the foregoing. The embodiments in the foregoing are used merely to explain selected aspects or steps that may be utilized in implementations of the present invention. Some embodiments may be presented only with reference to certain example aspects of the invention. It should be appreciated that corresponding embodiments may apply to other example aspects as well.

### BRIEF DESCRIPTION OF THE DRAWINGS

For a more complete understanding of example embodiments of the present invention, reference is now made to the following descriptions taken in connection with the accompanying drawings in which:

FIG. 1 shows an architectural drawing of a system of an example embodiment;

FIGS. 2a to 2f shows different examples for illumination light sources blockages that define the range in which the illumination can reach;

FIG. 3 shows a block diagram of an apparatus according to an embodiment of the invention;

FIGS. 4a to 4d illustrate examples on that how different illumination light sources can relate to a proximate object and be directionally adjusted;

FIG. 5 shows a flow chart that illustrates a method of an example embodiment corresponding to a first example aspect; and

FIG. 6 shows a flow chart of a process of an example embodiment.

### DETAILED DESCRIPTION OF THE DRAWINGS

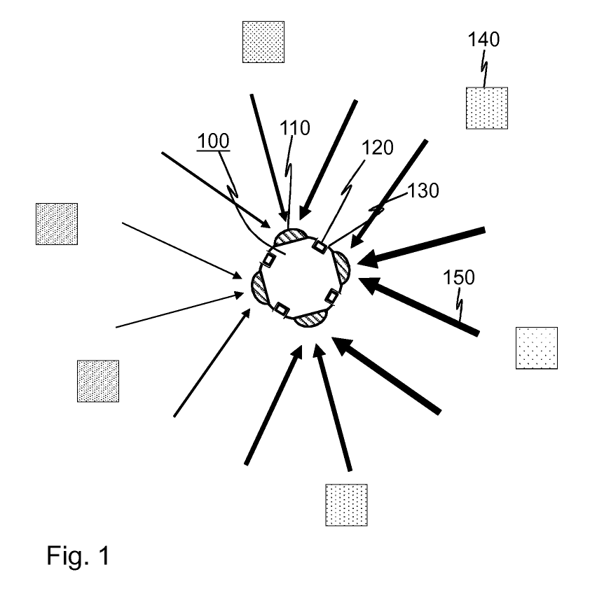

An example embodiment of the present invention and its potential advantages are understood by referring to FIGS. 1 through 6 of the drawings. In this document, like reference signs denote like parts or steps.

This document is organized such that first some structural parts are described with generic terms and then various details are described in subsections generally relating to some general topic. This organizing is made solely to simplify the disclosure of various implementations. It should be appreciated that any or all features of the different implementations may be freely used or omitted from particular implementations.

FIG. 1 shows an architectural drawing of a system of an example embodiment. FIG. 1 shows a panorama camera 100 comprising a plurality of camera objectives 110, a plurality of illumination light sources 120, a plurality of blockages 130, simplified imaging objects 140, and incoming light intensity symbols 150. The incoming light intensity symbols 150 are the wider the more light the panorama camera 100 receives from respective direction. The image objects 140 are correspondingly drawn with lighter patterns on corresponding regions, e.g. in sectors with more ambient light or lighter colors (because of illumination or better reflecting surfaces, for example).

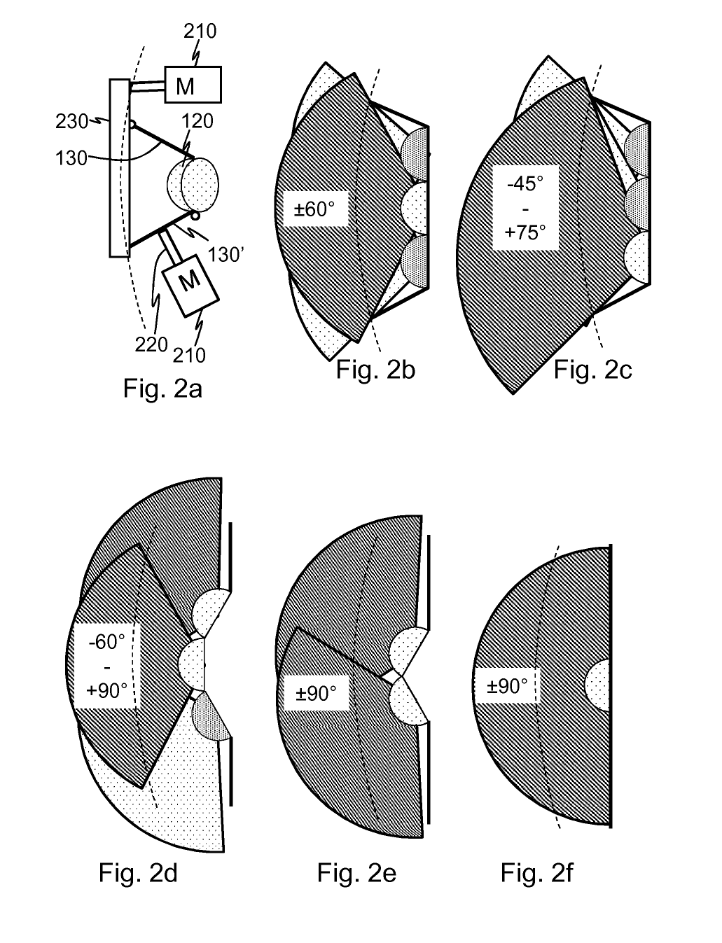

FIGS. 2a to 2f shows different examples for illumination light sources blockages that define the range in which the illumination can reach. FIG. 2a also shows a side view of one stationary blockage 130 (a wall, for example) and of one adjustable blockage 130′ as well as an actuator such as micro motor 210 (here drawn as a linear motor) and a transmission shaft 220 to actuate the adjustable blockage 130′ with the actuator. In some embodiments there are more than one actuators for driving one blockage 130. In some embodiments, there are more than one blockages driven by one actuator. The blockage may be formed of one planar object. Alternatively, the blockage may comprise a non-planar object and/or two or more planar objects. For example, a conical, cylindrical or by profile, rectangular, blockage may be movably supported so that the blockage is movable by tilting and/or shifting with relation to one or more illumination light sources with which the blockage co-operates. Co-operating in this context may refer to defining the range that the illumination light source can illuminate. Moreover, the blockage can further double as a reflector i.e. a blocking object may block entirely or partly passage of light through, but simultaneously reflect some of incident light.

FIG. 2a further shows a refracting element 230 such as a lens or prism that is here actuatable by another actuator 210. Hence, the range of illumination can be adjusted with FIG. 2a arrangement with both adjustable blockage 139′ to allow more or less illumination towards the lower left-hand side region and with the adjustable refractor 230 to direct more light to the upper left-hand side region, in terms of FIG. 2a directions. Of course, panorama camera imaging can be performed in generally horizontal, generally vertical or diagonal directions as well so these directions are merely illustrational.

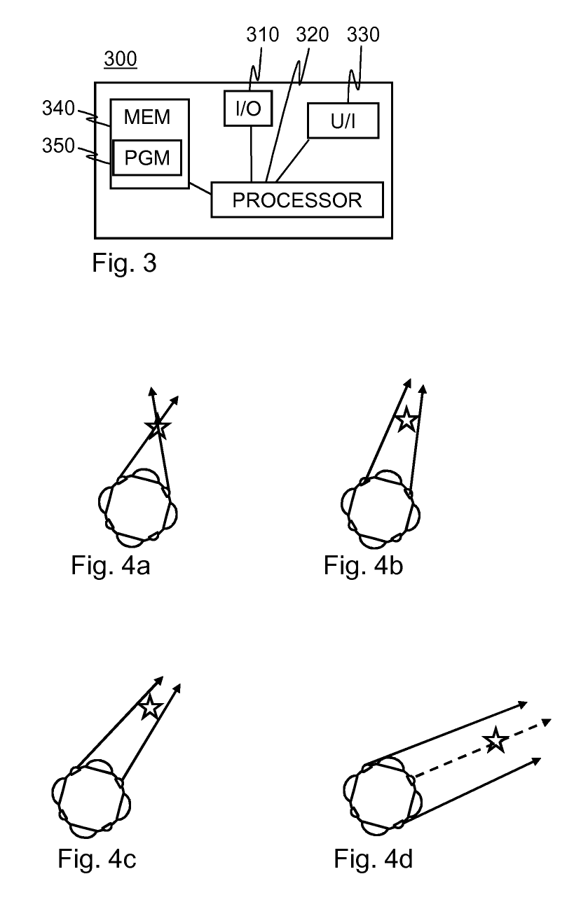

FIG. 3 shows a block diagram of an apparatus 300 according to an embodiment of the invention. In an embodiment, the apparatus 300 can be used as a controller of the panorama camera 100 to control the operation of the panorama camera 100.

The apparatus 300 comprises a memory 340 including a persistent computer program code 350. The apparatus 300 further comprises a processor 320 for controlling the operation of the apparatus 300 using the computer program code 340, a communication circuitry 310 to enable communication between different apparatus and controlled device such as the panorama camera 100 and communications with external entities. The communication circuitry 310 comprises, for example, an internal bus circuitry for implementing a data bus such as the Peripheral Component Interconnect (PCI) bus, local area network (LAN) port; a wireless local area network (WLAN) circuitry or Universal Serial Bus (USB) Bluetooth circuitry; cellular data communication circuitry; or satellite data communication circuitry. The processor 320 comprises, for example, any one or more of: a master control unit (MCU); a microprocessor; a digital signal processor (DSP); an application specific integrated circuit (ASIC); a field programmable gate array; and a microcontroller. In an example embodiment, the apparatus 300 comprises one or more antennas for wireless communications. For example, the captured images and/or the control of the imaging (including) can be exchanged over a wireless connection with an external controlling device such as a mobile phone equipped with suitable software.

### Definitions

Field of view of an objective or view in short: a view or an angular range that is being contained in photographic image capture;
Panorama camera: a camera capable of capturing an image covering at least 270 degrees e.g. by stitching two or more adjacent images that typically have some overlap. Intended to include also full-view (360×180 degree) imaging i.e. the panorama image may cover a semi-spherical or greater range of the surroundings.
Illumination light source: any light such as a flash bulb, light emitting diode, collimated light, which is generally suited for photographing illumination to assist exposure of still or video images.

Per Need Adaptive Illumination Intensity

Generally speaking, the illumination intensity can be adapted as needed with any of numerous techniques. The adapting per need may be understood as directional adaptation so that generally the views of the objectives when captured by image sensor(s) would be sufficiently uniformly exposed. Roughly speaking, this adaptation is made in some example embodiments: by choice of lamps; by control of power (dimming one or more illumination light sources), by adjusting optical paths; by reconfiguring blockage; by moving blockages such as walls; by moving one or more of the illumination light sources with respect to a co-operating blockage; by choice of illumination light sources for desired blockage or adjusting their mutual power; by reconfiguring refractor(s) co-operating with the illumination light source(s); and/or by reconfiguring reflection of the illumination light.

The range of each illumination light source depends on the geometry of the light source and the blockage. If plural light sources reside next to one blockage, the choice or power distribution between these light sources can be used to define desired directional intensity distribution from one group of illumination light sources. Further directional intensity adaptation can be produced by using spaced apart illumination light sources or their groups by power distribution suited to illuminate different ranges around the panorama camera with desired intensities. See E.g. FIG. 1 where different illumination light sources 120 in about 90 degrees different directions could be used to illuminate different quadrants of FIG. 1 surroundings around the panorama camera 100 with desired intensities.

Per Need Adaptive Spectrum Control

Desired directional spectrum control or adaptation can be obtained typically by using one or more of the following techniques: distributing power of different light sources that illuminate at least partly same region and that have produce different spectral power distribution; controlling the spectral power distribution of individual illumination light source(s); controlling coloring of refracted illumination light; and controlling coloring of reflected illumination light. The distributing of the power of different light sources in a controlled fashion can be performed at simplest by increasing or decreasing power of particular illumination light sources, but alternatively this could also be implemented by varying distribution of the illumination output particular light sources between two or more different illumination directions.

The spectral power distribution of one illumination light source can be simply adapted in case that its light is produced by plural separately driven sub-components in which case their driving can be balanced as desired. Another example involves the use of an illuminator that is operated to produce one or more pulses. If the spectral power distribution varies in a known manner as a function of time elapsed since the start of the pulse or as a function of the power of the pulse, then the spectral power distribution can be controlled by determining pulses of desired length. A suitable illumination power level can then be controlled by adjusting the power of the pulse. On the other hand, if the power of the pulse is adjusted to produce better spectral power distribution, the illumination power can be adjusted by controlling the duration of the pulse or the number of pulses.

The refraction and reflection can be simply colored by placing transparent or reflective (the latter rather in case of reflection) display element such as a liquid crystal display element on top of a refractor or reflector to controllably bias the spectral power distribution of the illumination.

Measurement

In order to directionally adapt the illumination, it is useful to measure ambient light. Of course, the controlling of the spectrum and/or the intensity of the illumination can be also used to calibrate the equipment so that individual differences of illumination light sources or image sensors can be compensated, for example, without measuring of the ambient light. Moreover, in some use cases, the panorama imaging can be performed in well-defined illumination conditions that are otherwise measured or known, in which case the spectrum and/or intensity of illumination may be directionally adjusted accordingly. Further still, the determination of desired adjustment can be received from a user and then performed with equipment configured to implement an embodiment of the present invention. For automatic operation, it is yet useful to automatically measure ambient light and to directionally adjust the illumination accordingly in order to reduce spectral variation and/or luminosity variation in the imaged surroundings of the panorama camera.

The ambient light measurement can be performed using known ambient light sensors, such as particular pixels or pixel ranges of an image sensor used for this purpose or separate light sensors. The ambient light measurement can also be performed by analyzing the images produced by the different image sensors and deducing based on the color channels (e.g. histogram analysis) which of the image sensors produces most likely correctly reproduces the colors of the surroundings or which part of a particular image sensor best performs with this respect. Then, the illumination can be directionally adjusted for other regions in order to reduce the differences. For example, an omni-imaging panorama camera image taken in a car may image dark interior parts as well as bright daylight scene through a window so that the white balance would be disturbingly askew in some parts of the panorama image. Moreover, in this example, it is clear that there may be no point in using a flash towards a bright area although the excessive contrast in brightness often leaves nearby objects such as faces unrecognizable unless illuminated from the direction of the panorama camera.

In an example embodiment, the ambient light measurement is determined separately for different sides of the view of one objective. The illumination may then be controlled accordingly to the extent possible by directionally adjusting such illumination light sources that at least partly illuminate the view in question. For example, in some cases, there are two illumination light sources on opposite sides of an objective configured to illuminate the entire view of this objective in question. In this case, the power distribution can be varied between these illumination light sources suitably to produce a desired white balance in images captured through the objective in question. Now, the spectral power distribution of these two light can be controlled such that they generally conform to the directional changing of spectrum of light around the panorama camera so that also adjacent other objectives can produce light of desired spectrum for imaging. In the control of the adjacent illumination light sources, a predictive or iterative calculation can be performed so as to reach an illumination scheme in which the difference in brightness and in white balance is maintained within a predetermined threshold. This threshold may be global over the entire panorama range or relative threshold so that the difference over adjacent region of N pixel rows or columns must remain within set limit.

In an example embodiment, proximate objects are also measured or determined in order to control the directional adjustment of the illumination suitably. For example, if an object of interest appears near a bright light, a strong illumination is useful to illuminate that object. Moreover, objects near objectives and particularly of light or reflective surfaces tend to become over-exposed in flash imaging in particular. Therefore, the objects near or particularly visible to the panorama camera when illuminated can be determined using suitable measurement. For example, an infrared illumination and imaging can be performed to detect directions and ranges of proximate and/or reflective objects for control of the directional adaptation. In some example embodiments, the illumination light sources or some of them are configured to produce infrared light suited for invisible detection of the proximate objects. In an example embodiment, an object is detected as being reflective or proximate when more than a predetermined proportion of illumination is received from a direction being illuminated. The predetermined proportion can be freely set according to implementation and it can also be adaptive according to ambient illumination level, for example. In an example embodiment, the proximate or reflective objects are determined based on image brightness in the direction of the object approaching a burn out limit, i.e. near 100 brightness. Such a limit could be, for example, 90% or 95% of the maximum brightness in one or more color channels (e.g., red, green or blue).

In some example embodiments, the detection of proximate objects is performed by use of 3D camera setup with visible or invisible wave lengths such as infrared light. A depth map is produced in some example embodiments to store information of the ranges and relative directions of proximate objects. These data can be used to adjust the illumination so as to reduce the likelihood that dark or erroneously colored images are taken while avoiding also the risk of burning some regions with excessive illumination beyond digital repair.

Multiframe Flash

In still imaging, the illumination is typically produced as brief illumination pulses often referred to as flash light, based on resemblance with the flash light that appears on thundering. In some example embodiments of the present invention, pulsed illumination is employed for video imaging as well so that for each frame in a sequence of frames forming video footage, illumination is produced by one or more flash pulses. The multiframe flash means that there are more than one flashes per image exposure. These flashes can be formed by using differently the illumination light sources so that the combination of the flashes produces a desired spectral power distribution and/or intensity distribution in the imaging range.

The multiframe flash can particularly well combine the adaptation techniques that do not require movement of objects, but in some embodiments also movements can be made between or even during the flashes.

3D Imaging

The panorama camera is a 3D camera in an example embodiment. In such a case, there are plural groups of 3D camera units, typically formed of two objectives and respective image sensors. The illumination can then be directionally adapted for each of these 3D camera units as for 2D cameras.

It should be borne in mind that the directional adaptation of the illumination can be implemented in various ways and with varying precision or resolution so to say. In an example embodiment, a proximate object is illuminated with a first spectral power distribution and intensity, while surfaces farther apart are but near the proximate object are differently illuminated. It may happen, that one of the 3D camera units sees the proximate object and the other 3D camera unit sees a background area behind that proximate object and with well adapted illumination, both areas could be optimally illuminated even though one is artificially illuminated and the other one by natural light, for example.

Indications with Illumination Light Sources

In an example embodiment, the illumination light sources can be doubled to operate both for illumination of imaging regions and also for displaying of indications to the user or others. These indications can be even used by other devices with suitable optical recognition.

For example, in one embodiment, a count-down timer operation is indicated with a progress indicator that is formed by selectively illuminating particular one or more of the illumination light sources. For example, a progress bar or rotating sphere or other indication can be formed by driving the illumination light sources selectively and often with lowered power. Also letters or digits can be formed. In case of collimated light sources, such indications can further be displayed on proximate surfaces as if projected there.

In one embodiment, the illumination light sources are used to indicate coming seam ranges of the panorama image. The seam regions are often of lower quality than others and it can help a photographer to better align or direct the panorama camera or the audience to settle at better positions if the seam regions are perceivably indicated as illuminated regions or less illuminated regions, for example.

FIGS. 4a to 4d illustrate examples on that how different illumination light sources can relate to a proximate object and be directionally adjusted. In FIG. 4a, an object is illuminated with two light sources and likely to be over-exposed. In FIG. 4b, the illumination is symmetrical around the object but does not directly illuminate the object. Notice that in practice, the illumination is not produced with an arrow narrow beam (that would be easy to produce with a laser but rarely useful in panorama imaging). Instead, FIG. 4b can be understood to show one boundary of a range that extends largely outwards from the arrow. In FIG. 4c, one light source is far closer to the object than the other. Given that the power of the illumination decreases drastically as a function of distance, the illumination provided by the nearer light source is far more prominent. In FIG. 4c, the light sources are yet so directed that neither one is likely to over-expose the object. FIG. 4d shows a situation in which the object is near the ranges of two illumination light sources and straight ahead of one. In this case, the nearest light source could be dimmed.

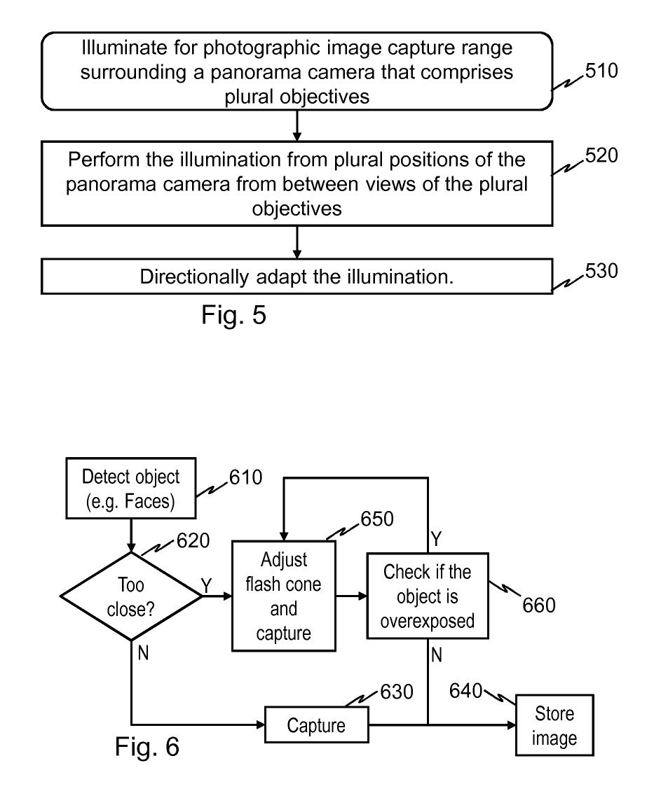

FIG. 5 shows a flow chart that illustrates a method of an example embodiment corresponding to a first example aspect. The method comprises: illuminating 510 for photographic image capture of a range surrounding a panorama camera that comprises plural objectives; performing 520 the illumination from plural positions of the panorama camera from between views of the plural objectives; and directionally adapting 530 the illumination.

FIG. 6 shows a flow chart of a process of an example embodiment. This process exemplifies how some of the techniques described in the foregoing can be used in one use case. First, objects near the panorama camera are detected, 610. Face recognition is one technique that is suited for detecting objects that are also likely to be of interest. The distance to the detected object(s) is determined and it is compared if the object is too close for likely success if photographed as such, 620. If the distance is fine i.e. the object is not too close, an image is captured 630 and stored 640 in memory. If the object is too close, on the other hand, the process continues to step 650 to adjust flash cone of related one or more illumination light sources that would likely illuminate the object and to capture an image. The image is then checked for over-exposure, 660. If the image was not over-exposed, the process continues to step 640, otherwise the process resumes to step 650 (unless the count of unsuccessful attempts exceeds a pre-set limit).

Without in any way limiting the scope, interpretation, or application of the claims appearing below, a technical effect of one or more of the example embodiments disclosed herein is that evenness of illumination may be significantly improved in a 2D or 3D panorama imaging around a camera. Another technical effect of one or more of the example embodiments disclosed herein is that the evenness of the illumination may be performed to increase evenness in both intensity and spectrum of the illumination. Yet another technical effect of one or more of the example embodiments disclosed herein is that objects of different distance or reflectance may be illuminated with directional adaptation configured to reduce unevenness that could otherwise be caused by the illumination of the panorama camera. Yet another technical effect of one or more of the example embodiments disclosed herein is that the illumination may be automatically and continuously and directionally adapted so as to account for changes in the photographing conditions. Yet another technical effect of one or more of the example embodiments disclosed herein is that the illumination may be directionally adapted for intensity and/or spectrum for even illumination of entire panorama imaging area.

Embodiments of the present invention may be implemented in software, hardware, application logic or a combination of software, hardware and application logic. The software, application logic and/or hardware may reside on a controller 300 or a panorama camera 100. If desired, part of the software, application logic and/or hardware may reside on the controller 300, part of the software, application logic and/or hardware may reside on the panorama camera 100, and part of the software, application logic and/or hardware may reside on an external control device such as a remote controller (e.g. mobile phone). In an example embodiment, the application logic, software or an instruction set is maintained on any one of various conventional computer-readable media. In the context of this document, a “computer-readable medium” may be any non-transitory media or means that can contain, store, communicate, propagate or transport the instructions for use by or in connection with an instruction execution system, apparatus, or device, such as a computer, with one example of a computer described and depicted in FIG. 3. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the before-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the foregoing describes example embodiments of the invention, these descriptions should not be viewed in a limiting sense. Rather, there are several variations and modifications which may be made without departing from the scope of the present invention as defined in the appended claims.

1. A method comprising:
illuminating for photographic image capture a range surrounding a panorama camera that comprises plural objectives;
performing the illumination from plural positions of the panorama camera from between views of the plural objectives; and
directionally adapting the illumination.

2. The method of claim 1, further comprising measuring illumination need as a function of direction and accordingly performing the directional adapting of the illumination.

3. The method of claim 1, wherein:
the illumination is performed in a plurality of sectors collectively covering the entire field of view of the panorama cover, and/or
the illuminating is flash light illuminating, and/or
the illuminating for photographic image capture comprises illuminating with two or more illumination light sources on different sides of one of the plural objectives to illuminate the field of view of the objective in question, and/or
the illuminating is performed using multi-frame flashing in which plural flash pulses are issued in respective different periods during exposure of one image by the panorama camera.

4. The method of claim 1, further comprising stitching a panorama image using the image information.

5. (canceled)

6. The method of claim 1, wherein the illuminating is continuous illuminating.

7. The method of claim 1, wherein the illuminating is continuous illuminating during one period of time and a flash light illumination during another period of time.

8. The method of claim 1, wherein:
the directional adapting of the illumination directionally varies intensity of the illumination, and/or
the directional adapting of the illumination varies mutual intensities of plural illumination light sources, and/or
at least some of the plural illumination light sources are dimmed, and/or
at least some of the plural illumination light sources are switched off, and/or
the plural illumination light sources are grouped in plural groups comprising one or more light sources, wherein the varying of the mutual intensities comprises varying mutual intensities of different illumination light sources within different groups so that each of the groups of light sources illuminates with desired collective power and spectral power distribution.

9. (canceled)

10. (canceled)

11. (canceled)

12. (canceled)

13. (canceled)

14. The method of claim 1, wherein the directional adapting of the illumination comprises adjusting optical path of an illumination light source.

15. The method of claim 14, wherein:
the adjusting of the optical path comprises reconfiguring a blockage for the illumination light source, and/or
the reconfiguring of the blockage comprises any one or more of: moving a blocking object; moving the illumination light source with respect to the blocking object; and adapting mutual intensities of one or more of plural light source that are partly blocked by the blocking object, and/or
the plural light sources that are partly blocked by the blocking object reside in a non-planar constellation, and/or
the adjusting of the optical path of the at least one illumination light source comprises moving an optical path directing element by an actuator, wherein the optical path directing element comprises at least one reflector; refractor; or reflector and refractor, and/or
the adjusting of the optical path of the illumination light source comprises adapting refraction of at least one cooperating refractor, and/or
the refractor comprises any one or more of: a lenslet; liquid crystal polarization rotator; and an actuated refractor.

16. (canceled)

17. (canceled)

18. (canceled)

19. (canceled)

20. (canceled)

21. (canceled)

22. (canceled)

23. The method of claim 14, wherein the adjusting of the optical path of the at least one illumination light source comprises adapting reflection of least one co-operating reflector.

24. The method of claim 23, wherein:
the reflector comprises a mirror or a plural micro-mirrors configured to reflect the illumination to desired direction, and/or
the mirror or micro-mirrors resides underneath the illumination light source, and/or
the adapting of the reflection comprises selective blocking or absorption of illumination with a liquid crystal display screen.

25. (canceled)

26. (canceled)

27. The method of claim 1, wherein the directional adapting of the illumination directionally varies the spectrum of the illumination.

28. The method of claim 27, wherein:
the spectrum of the illumination is controlled by adapting the spectrum of one illumination light source and/or a collective spectrum of plural illumination light sources, and wherein the spectrum of one illumination light source is controlled by adapting the driving or pulse period of the illumination light source in case that the spectral response of the illumination light source is variable as a function of time, and/or
the spectrum of the illumination is controlled by adapting mutual intensities of different sub-band illuminators that are configured to produce different sub-bands of desired spectrum of the illumination, wherein the spectrum of the illumination is controlled by adapting absorption spectrum of an adjustable absorption element configured to co-operate with one or more illumination light sources and the adapting of the absorption spectrum is performed with a controllably coloring the absorption element such as a colored liquid crystal display element, and the adapting of the absorption spectrum is performed with dedicated controllable absorbers assigned for different sub-band illuminators.

29. (canceled)

30. (canceled)

31. (canceled)

32. (canceled)

33. (canceled)

34. The method of claim 1, comprising determining desired spectrum of the illumination based on output of the panorama camera, wherein the desired spectrum is defined based on a choice of most likely successful image out of a plural images captured with the plural objectives.

35. (canceled)

36. The method of claim 1, comprising defining the desired spectrum for an illumination light source based on measurement of spectral power distribution of ambient light.

37. (canceled)

38. The method of claim 3, wherein, when the illuminating for photographic image capture comprises illuminating with two or more illumination light sources on different sides of one of the plural objectives to illuminate the field of view of the objective in question, the two or more illumination light sources are configured to collectively produce a desired spectral power distribution, and the desired spectral power distribution is directionally variable within the field of view of the objective in question.

39. (canceled)

40. (canceled)

41. The method of claim 3, wherein, when the illuminating is performed using multi-frame flashing in which plural flash pulses are issued in respective different periods during exposure of one image by the panorama camera, the plural flash pulses differ by at least one of their directional power distribution; spectral power distribution variance as a function of direction; global power; and global spectral power spectrum.

42. The method of claim 1, further comprising:
using one or more of the illumination light sources as photographing light to assist exposing images by the panorama camera and additionally as an infrared light illumination, and
using the infrared light illumination to obtain a depth map of proximate objects,
wherein the depth map is used to control the directional adapting of the illumination.

43. (canceled)

44. (canceled)

45. The method of claim 1, further comprising automatically verifying disparity of a pair of images when the panorama camera is used for 3D imaging, wherein if disparity exceeding a given threshold is identified, the illumination is directionally adapted with such directional adaptation that the disparity is decreased to facilitate 3D imaging.

46. (canceled)

47. The method of claim 1, further comprising presenting an indication with the illumination light sources, wherein the indication comprises any of: a graphical symbol; digit; and letter, and further comprising using the indication to identify on proximate surfaces where seam regions will reside in subsequent stitching of panorama images given the position and orientation of the panorama camera.

48. (canceled)

49. (canceled)

50. A panorama camera comprising:
a plurality of objectives configured to produce frames for a panorama image; an image capture circuitry configured to obtain digital images corresponding to the views of the plural objectives;
a plurality of illumination light sources configured to produce illumination from plural positions of the panorama camera from between views of the plural objectives; and
a controller configured to directionally adapt the illumination comprising adjusting optical path of an illumination light source.

51. The panorama camera of claim 50, wherein:
the controller comprises at least one processor configured to receive image information from the image capture circuitry and to process the image information, and/or
the controller is configured to stitch a panorama image using the image information, and/or
the panorama camera is capable of capturing an image covering at least 270 degrees, and/or
the panorama camera is a 3D camera.

52. (canceled)

53. (canceled)

54. (canceled)

55. An apparatus comprising:
a communication circuitry configured to receive image information from a panorama camera comprising plural objectives, the image information corresponding to views of the plural objectives;
a controller configured to control illuminating for photographic image capture a range surrounding the panorama camera from plural positions of the panorama camera from between views of the plural objectives and to cause directionally adapting the illumination comprising adjusting optical path of an illumination light source.

56. (canceled)

57. (canceled)
